(19) United States
(12) Patent Application Publication
(10) Pub. No.: US 2009/0248426 A1
(43) Pub. Date: Oct. 1, 2009

(54) MEETING MANAGEMENT SOFTWARE THAT DISTINGUISHES STAFF FROM OTHER MEETING INVITEES AND PERMITS STAFF BASED PROGRAMMATIC ACTIONS

(75) Inventor: BILL D. LE, EVERETT, MA (US)

Correspondence Address: PATENTS ON DEMAND, P.A. - IBM CAM, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/054,820

(22) Filed: Mar. 25, 2008

(51) Int. Cl. G06Q 10/00

(52) U.S. Cl. 705/1

(57) ABSTRACT

A staff's element of a user interface for editing or adding meeting software objects can be identified. The staff's element can be one of a many different interface elements. Other ones of the interface elements can accept input that define participants of a meeting who are not considered staff. Input entered into the staff's element can be received. A set of at least one user considered staff can be parsed from the received input entered into the staff's element. A unique identifier can be determined for each staff user in the parsed set. At least one record can be stored in a meeting data store that indexes each of the determined unique identifiers against a meeting identifier such that these determined unique identifiers signify that associated users are to be considered staff for a meeting object associated with the meeting identifier.

### BACKGROUND OF THE INVENTION

The present invention relates to the field of meeting management software and, more particularly, to meeting management software that distinguishes staff from other meeting invitees and permits staff based programmatic actions.

Meeting management software provides a convenient method to communicate with a multitude of individuals, to initiate meetings, to maintain a calendar of appointments, to track meeting action items, and the like. Meetings include physical meetings occurring in a specific place at a specific time, include virtual meetings conducted through telepresence technologies, and include hybrids of the two. One often utilized feature of meeting management software initiates, conveys, accepts/denies, and tracks a status of meeting invitations.

When establishing an invitation, an initiator (referred to as a meeting chairperson) is typically presented with fields for defining meeting times, a meeting location, meeting details, and meeting attendees. For example, a “when” section can allow the chairperson to establish a start time, an end time, and whether the meeting is a one-time event or a periodic event. The “where” section can define a location, room, a set of resources, and telepresence options. The “description” section can define meeting topic, an agenda, a comments section, and can permit documents to be attached and disseminated to the invitees. The “who” section can define a set of invitees sometimes categorized by required attendees, optional attendees, and attendees listed for information purposes only (FYI).

One weakness with current implementations is that no designation exists for distinguishing meeting staff from other attendees. Meeting staff are members who are responsible for one or more facets of a meeting. For example, presenters of content, coordinators of groups, acquisitioners of resources, and the like can be considered meeting staff.

This lack of an ability to distinguish staff can add significantly to chairperson overhead, whom often has to create individualized messages outside the invitation to these members. Further, these staff directed messages are often “outside the system” and are therefore not centrally tracked and managed by the meeting system. Also, as changes occur affecting staff and meeting details, manual (non system assisted) actions are often needed, which adds to collaboration overhead and can lead to mistakes affecting the meeting. For example, presently a change affecting staff requires a coordinator to look up all staff members, individually add them to a communication, and convey the change within a communication. This manually driven and inefficient process makes it very easy to overlook an important staff member, who may be responsible for performing an action related to the conveyed communication. In short, a lack of an ability to distinguish staff from other meeting invitees hinders the meeting coordination process that is antagonistic to the purpose of the meeting management software. That is, a purpose of meeting management software is to automate recurring tasks, to minimize manual coordination requirements, and to track and centrally manage meeting specifics so that manual and “out-of-system” planning and coordination activities required by human agents are minimized.

### BRIEF SUMMARY OF THE INVENTION

One aspect of the present invention can include a method, computer program product, system, and/or device for designating staff of a meeting. A staff's element of a user interface for editing or adding meeting software objects can be identified. The staff's element can be one of a many different interface elements. Other ones of the interface elements can accept input that define participants of a meeting who are not considered staff for that meeting. Input entered into the staff's element can be received from a user. A user selection to save details of a currently presented meeting object can be present in the user interface. A set of at least one user considered staff can be parsed from the received input entered into the staff's element. A unique identifier can be determined for each staff user in the parsed set. At least one record can be stored in a meeting data store that indexes each of the determined unique identifiers against a meeting identifier such that these determined unique identifiers signify that associated users are to be considered staff for the meeting object.

Another aspect of the present invention can include a system for managing meetings where staff are distinguished from other meeting participants. The system can include a meeting management software program, a meeting data store, and a user interface. The meeting management software program can receive, manage, and store meeting specific information and can perform a set of programmatic actions related to the meeting specific information. The meeting data store can store digitally encoded information that includes the meeting specific information used by the meeting management software program. The user interface can include a meeting establishment view. The meeting establishment view can include a set of interface controls for establishing specifics for a new meeting. The meeting establishment view can also include a staff's element configured to accept input defining at least one user who is to be considered a staff member for the meeting.

Still another aspect of the present invention can include a user interface that includes a location section, a time section, and a participant section. The location section can be configured to establish location specifics for a meeting based on user input. The time section can be configured to establish time specifics for the meeting event based upon user input. The participant section can be configured to establish at least one user who are to receive information for the meeting. The information for the meeting can include the established location specifics and the established time specifics. The participant section can include a staff's element. The staff's element can be configured to accept input defining at least one user who is to be considered a staff member for the meeting.

### BRIEF DESCRIPTION OF THE SEVERAL VIEWS OF THE DRAWINGS

FIG. 1 is a schematic diagram of a system for meeting management that distinguishes staff from other meeting participants and permits staff based programmatic actions to occur in accordance with an embodiment of the inventive arrangements disclosed herein.

FIG. 2 is a flow chart of a method illustrating an establishment and use of a staff specific designator within a meeting management software system in accordance with an embodiment of the inventive arrangements disclosed herein.

FIGS. 3A and 3B (together considered FIG. 3) shows an interface for establishing a meeting, which permits a specific category of staff to be designed in accordance with an embodiment of the inventive arrangements disclosed herein.

FIGS. 4A and 4B (together considered FIG. 4) is a user interface showing a calendar entry for a meeting and a set of staff-related options in accordance with an embodiment of the inventive arrangements disclosed herein.

### DETAILED DESCRIPTION OF THE INVENTION

The present invention adds an ability to distinguish staff from other meeting participants in meeting management software. After staff is distinguished, it is considered a selectable “group” of meeting participants who can be targeted for subsequent messages. The staff group can be propagated throughout a meeting management software interface, which permits the selection of staff from any relevant meeting menu. For example, from a calendar view, a chairperson can select a meeting specific entry and be presented with a pop-up to assign a to-do event to staff, to chat with staff, to convey an email message to staff, to view staff involved in the meeting, and the like. These functions are available immediately and intuitively. Thus, a chairperson in charge of coordinating multiple meetings can send message to staff immediately upon selecting a suitable entry, even if he/she is unaware of who is considered staff (although that information is also readily available upon a few interface selections) for that particular meeting. As used herein, a meeting is to be defined broadly to include any specifiable occurrence or event having a set of participants, a defined time, and a venue. The venue need not be a physical location as it can also refer to an online site (i.e., a virtual meeting, a scheduled Web cast, an e-business or storefront sales event, and the like are all to be considered “meetings” within scope of the present invention.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

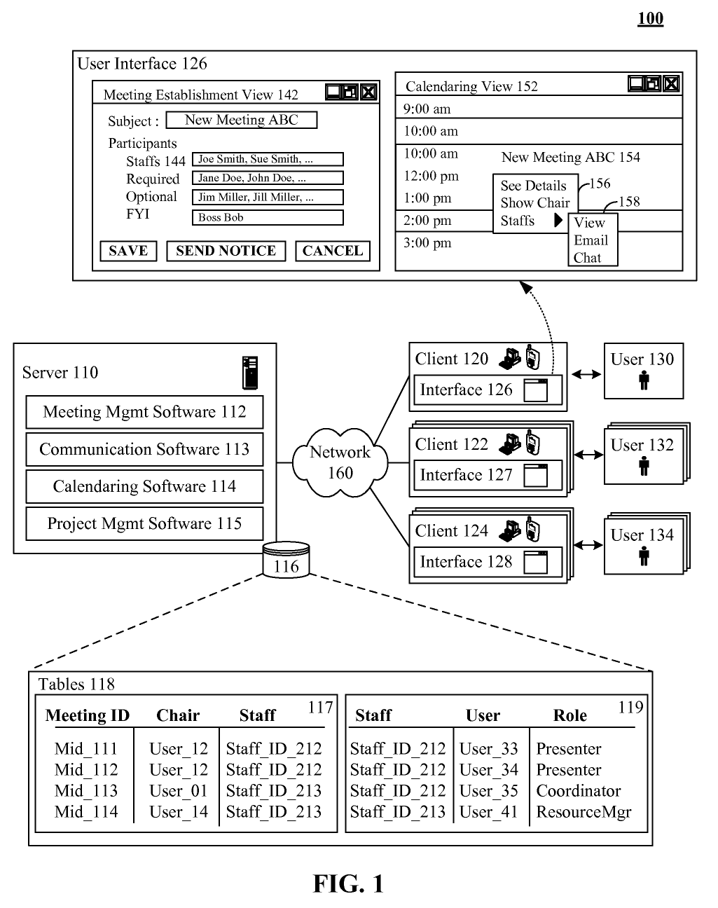

FIG. 1 is a schematic diagram of a system 100 for meeting management that distinguishes staff from other meeting participants and permits staff based programmatic actions to occur in accordance with an embodiment of the inventive arrangements disclosed herein.

In system 100, meeting data maintained in data store 116 can be established when a user 130, who can be a chairperson, establishes details for a meeting. These details can be established via a meeting establishment view 142 of a user interface 126 of client 120. One of the interface elements of view 142 can be a staff's element 144, within which a set of users (e.g., users 132) are able to be defined as staff for a specific meeting. Using view 142, the chairperson user 130 can also define another set of users (participant users 134) as non-staff meeting participants.

Once meeting details have been entered and recorded in a data store 116 containing indexed meeting data, which includes specifying a set of users as meeting staff, additional programmatic actions can be taken based upon the staff relationship. For example, a calendaring view 152 of interface 126 can present a meeting object 154 along with one or more staff specific options 156. For instance, the option 156 can permit a communication to be sent to users 132 designated as staff for the meeting object 154. Additional options 158 can be provided within the view 152, such as permitting a user 130 to view all staff users 132 for the meeting object 152, to initiate an email to the staff users 132, to initiate a chat session with all available staff users 132, and the like.

In one embodiment, meeting information can be stored and maintained using a stand-alone program, such as a program executing on client 120. In such an embodiment, user interface 126 can be an interface for the stand-alone program and the data store 116 in which meeting data is stored can be local to client 120. Communications with other users 132-134 can be initiated using client 120 driven communications, such as email, instant messages, and the like.

In another embodiment, a client-server arrangement can exist. For example, a server 110 can include meeting management software 112, which causes meeting data entered through user interface 126 to be stored in data store 116. When the interface 126 entered input is conveyed to the meeting management software 112, the interface 126 can be a client-side interface of a server program 126. In one embodiment, the client 120 can render Web pages forming the interface 126, which are served to the client 120 via a Web server.

Other client-side interfaces can also interact with the meeting management software 112 of server 1 10. For example, a user interface 127 of client 122 can be used by staff users 132 and a user interface 128 of client 124 can be used by participant users 134. Different types of users 130-134 can be presented with different interface options. For example, an interface 127 used by staff users 132 may permit limited communications with other staff members and/or a chairperson 130 based upon a selection of a meeting object 154 for which that user 132 is considered staff. An interface 128 of a participant user 134, however, may lack user selectable options relating to staff-based programmatic actions.

A client-server arrangement can be preferable for organizations and entities that manage meetings, meeting resources, and the like for a relatively large set of people, as it provides centralized management and organization of all meeting related information. It can also be easier to integrate centrally managed meeting data with a diverse set of related software applications 113-115.

As shown, the server 110 can store information in tables 118 of a data store 116. The meeting management software 112 can interact with one or more other software applications, such as communication software 113, calendaring software 114, project management software 115, and the like. For example, a common data store 116 can manage information used by multiple different software 112-115 components. In another example, a series of application program interfaces (APIs) can function as an interface between the meeting management software 112 and one or more other software applications 113-115. In still another example, functionality described for the meeting management software 112 and one or more of the other software programs 113-115 can be integrated into a single software suite or multifunctional software application.

The tables 118 can include multiple indexed records, such as records of a relational database management system (RDBMS). Assuming a RDBMS in third normal form (e.g., one contemplated embodiment of the invention), a meeting table 117 can be established, where a meeting identifier is a primary key, which has an attribute designating a meeting chairperson and an foreign key attribute for a unique staff identifier associated with that meeting. A staff-user associative table 119 can associate a set of zero-to-many user identifiers with a unique staff group id, and thereby define within a relational database which users are considered staff for a given meeting. Other RDBMS tables, such as a user table, a meeting table, and the like that utilize the meeting identifier, the user identifier, the staff identifiers, and the like, can be presumed to exist along with their associated attributes.

A similar set of relationships to that shown by tables 118 can be established using any of a variety of indexing or data maintenance mechanism (e.g., Indexed Sequential Access Method (ISAM) based databases, tables/files of table having searchable text, and the like). Hence, the system 100 is not to be construed as limited to a RDBMS implementation, whether the RDBMS is in third normal form or not.

As used herein, a meeting is defined as an occurrence or event involving said users 130-134. A meeting can also have an associated location and time. The meeting can include a physical gathering which one or more person is able to attend, a virtual meeting space, and combinations of the two. Meetings can include one-time occasions as well as repeating occurrences based upon a definable interval.

The meeting management software 112 can include a computer program product through which meetings are able to be defined. The meeting management software 112 can be an integrated component of a collaboration suite or can be a stand-alone program. For example, the meeting management software 112 can include, but is not limited to LOTUS SAMETIME, I-CALENDAR, SHAREPOINT, OFFICE LIVE, OUTLOOK, MS PROJECT, and the like.

User interfaces 126-128 can be implemented as graphical user interface (GUIs), Voice User Interfaces (VUIs), multi-modal interfaces, small device interfaces, embedded device interfaces, and the like. The views 142 and 152 can each represent a set of interactive components presented together. For example, each view 142, 152 can represent a set of interface controls having a related purpose.

Clients 120-124 can be any computing device capable of rendering a user interface 126-128. Clients 120-124 can include, for example, a personal computer, a notebook computer, a thin client, a kiosk, an embedded computing device, a smart phone, a personal data assistant, a wearable computer, an electronic gaming device, an internet appliance, a media player, a navigation device, and the like.

Network 160, which connects the clients 120-124 and server 110 to each other, can include any hardware/software/and firmware necessary to convey digital content encoded within carrier waves. Content can be contained within analog or digital signals and conveyed through data or voice channels and can be conveyed over a personal area network (PAN) or a wide area network (WAN). The network 160 can include local components and data pathways necessary for communications to be exchanged among computing device components and between integrated device components and peripheral devices. The network 160 can also include network equipment, such as routers, data lines, hubs, and intermediary servers which together form a packet-based network, such as the Internet or an intranet. The network 160 can further include circuit-based communication components and mobile communication components, such as telephony switches, modems, cellular communication towers, and the like. The network 160 can include line based and/or wireless communication pathways.

The information managed by server 110 and clients 120-124 can be stored in a one or more data stores, which includes data store 116. These data stores can be a physical or virtual storage spaces configured to store digital information. The data stores can be physically implemented within any type of hardware including, but not limited to, a magnetic disk, an optical disk, a semiconductor memory, a digitally encoded plastic memory, a holographic memory, or any other recording medium. Each of data stores can be a stand-alone storage unit as well as a storage unit formed from one or more physical devices. Additionally, information can be stored within the data stores in a variety of manners. For example, information can be stored within a database structure or can be stored within one or more files of a file storage system, where each file may or may not be indexed for information searching purposes. Further, the data stores can optionally utilize one or more encryption mechanisms to protect stored information from unauthorized access.

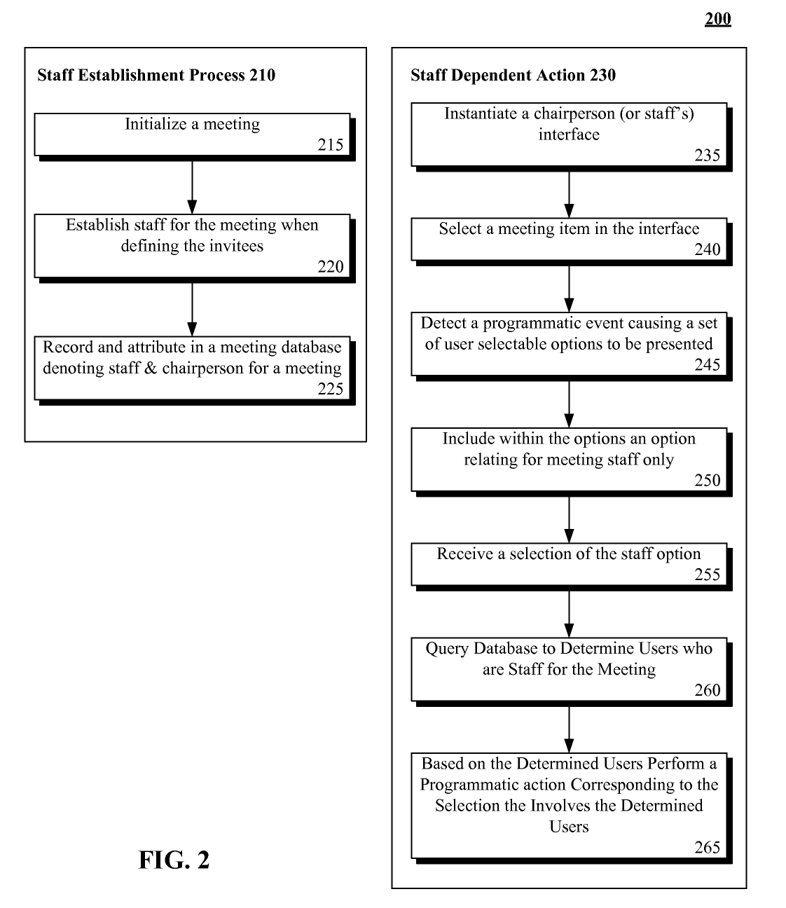

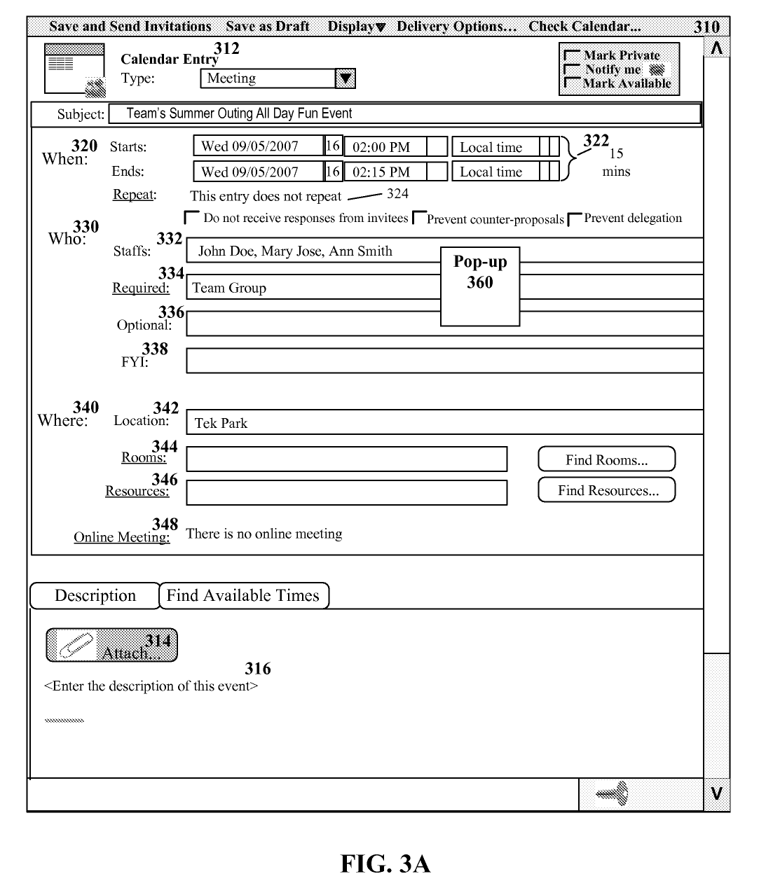

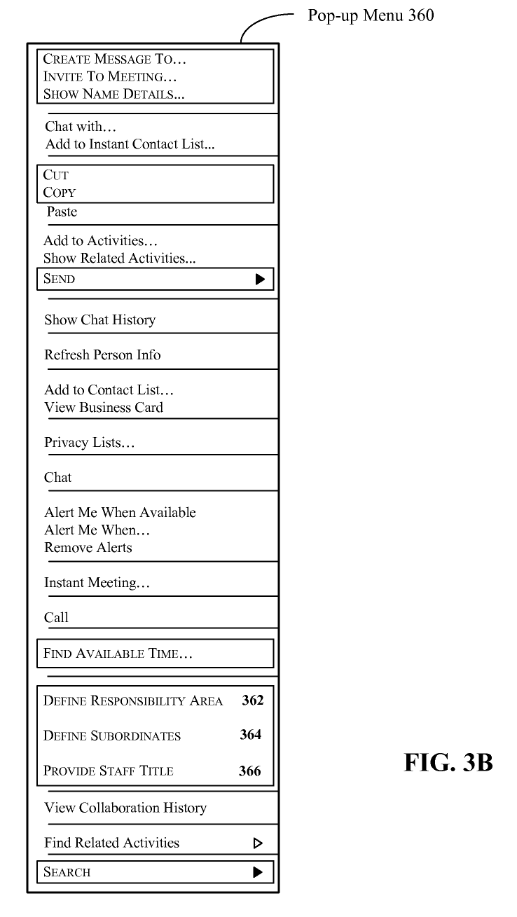

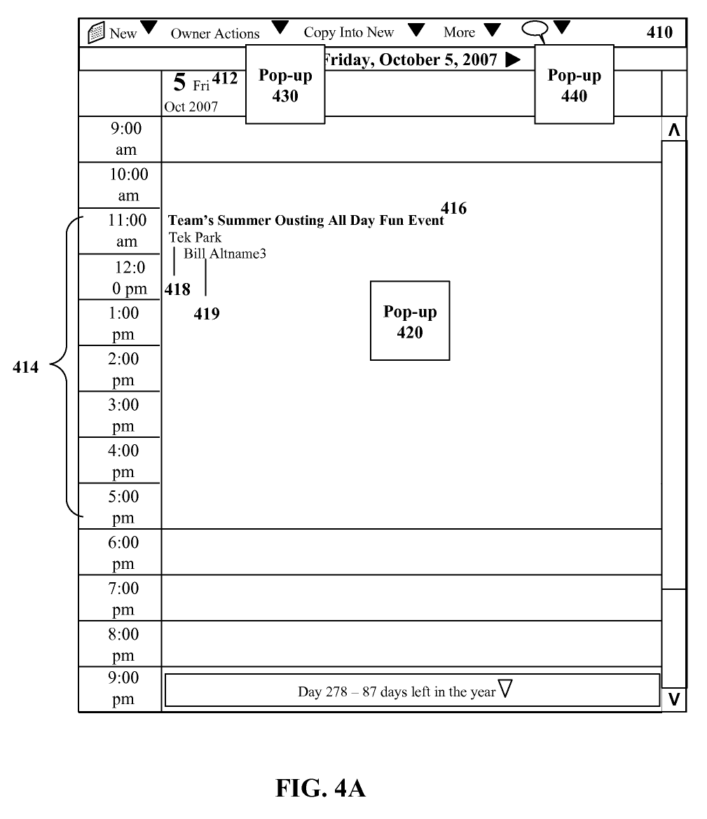

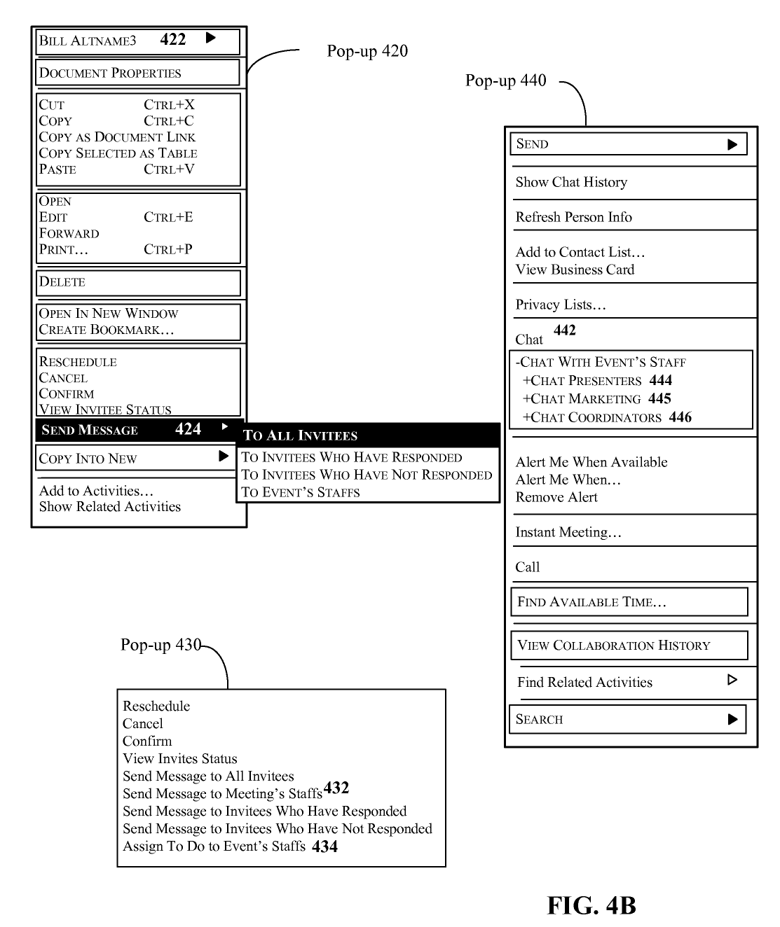

FIG. 2 is a flow chart of a method 200 illustrating an establishment and use of a staff specific designator within a meeting management software system in accordance with an embodiment of the inventive arrangements disclosed herein. The method 200 can be performed in the context of a system 100 or similar system and can utilize a variety of user interface, such as those of FIGS. 3-4. As shown, method 200 includes two distinct series of steps that can occur at different times, which include a staff establishment process 210 and a staff dependent action 230.

The staff establishment process 210 can begin at a time a meeting is initialized 215. During this process, staff can be established when a set of invitees are defined, as shown by step 220. For example, an interface control for a meeting invitation can be specific to those meeting participants who are staff. In step 225, an attribute can be stored in a meeting software system data store that denotes which system users are to be considered staff for the meeting. In one embodiment, these attributes can be stored in a relational data base system or other indexed/query-able manner.

At some point after an initial meeting invitation has been sent, at which time staff is established in accordance with process 210, a staff dependent action 230 can be performed. In one embodiment, this action can occur within an interface of a defined chairperson of an event. That is, the chairperson's interface can present staff specific actions and options, while other users of a meeting management software system will not be presented with staff specific options. In another embodiment, all (or a designated subset of) users of a meeting management software system will be presented with staff specific options, which are unavailable to general invitees. In one contemplated derivative of this option, a chairperson specific action/option can be presented within the meeting management software system to users designated as staff. In still another implementation of the invention, general invitees (or a designated subset of, such as those upper level managers who are supervisors of staff and/or a meeting chairperson) of the meeting management system will be presented with staff specific options. For illustrative purposes, a situation is assumed for action 230, where a chairperson initiates an interface.

The action 230 can begin in step 235, where a chairperson initiates a user interface for the meeting management system. In step 240, a meeting item can be selected or presented within the interface. In step 245, a programmatic event can be detected that causes a set of user selectable options to be presented within the interface. For example, a user can right mouse click on the presented meeting item. The programmatic event need not be a response to a user selection, but can include a response to a system event, such as an event triggered when the interface is instantiated or when a specific window of the user interface is presented. For example, a toolbar, menu bar, or other interface control that is automatically presented in an interface within which the meeting item of step 240 is presented.

In step 250, one of the meeting item specific options can include an option restricted to meeting staff. A selection of the staff specific option can be received in step 255. In step 260, a data store (e.g., the one referenced in step 425) can be queried to determine a set of users who are considered staff for the meeting associated with the meeting item. In step 265, a programmatic action corresponding to the option selection that involves the determined set of users can execute. For example, a chat session (assuming a chat with staff option is selected) can be initialized that involves only meeting staff. In another example, an email can be conveyed to staff and/or a to-do item can be assigned to a staff member. In yet another example, a pop-up displaying staff members can be presented to the chairperson within the user interface so that the chairperson can take an action involving one or more selected staff member from the pop-up. The programmatic actions of step 265 are not limited to these examples, and any definable action involving the users designated as staff can occur.

FIGS. 3A and 3B (together considered FIG. 3) shows an interface 310 for establishing a meeting, which permits a specific category of staff to be designed in accordance with an embodiment of the inventive arrangements disclosed herein. In one embodiment, the interface 310 can be an interface used in system 100 and/or method 200

Interface 310 permits an establishment of an entry 312 for a meeting. A meeting can be any event having a defined time and a defined set of participants. A description section of the interface 316 can provide general information concerning the meeting and can permit attachments 314 or electronic documents to be linked to the meeting and made available to meeting participants.

As shown the interface 310 can define a when section 320 for establishing a meeting time, a who 330 section for establishing a set of meeting attendees, a where section 340 for establishing a meeting location, and the like. Other meeting specific categories and attributes can be included and the interface is not to be restricted to those illustrative meeting elements shown.

The when section 320 can define a start and end time 322 as well as establish whether the meeting is a periodic one that is to repeated 324 at a defined interval. The where section 340 can define a location 342, one or more meeting rooms 344, one or more resources 346 needed for the meeting, and a set of online meeting options 348, if any.

The who section 330 can include “traditional” fields for required attendees 334, optional attendees 336, and for-your-information 338 attendees—who are to be informed of a meeting but who are not expected to attend. Additionally, a staff's field 322 can permit a set of meeting attendees designated as staff to be defined. The staff 332 can be a party having an administrative function related to the meeting. That is, a set of people defined in the staffs 332 field are those people which whom a chairperson coordinates meeting details. The personnel in staffs 332 can be programmatically linked to various appropriate data base records of a meeting management system. These records and links can provide a set of options, configurable or displayable upon a user selection of a staff member. For instance, a context sensitive menu 360 can pop-up for a given staff member when that member is selected (e.g., right-mouse clicked, for example) within the interface 310. One or more of the menu 360 items can be specific to staff designated users, and other menu 360 options can be generic to any system user.

In one embodiment (not shown), the interface 312 can include one or more configurable attributes on a per-person basis for those designated as staffs 332 so that specific areas of responsibility can be defined. For example, menu 360 can permit a chairperson or other authorized party using interface 310 to define an area of responsibility 362 for a given staff member. Other attributes definable for a staff member can include, but are not limited to, defining a staff title (e.g., program director, presenter, refreshment coordinator, etc.) associated with that staff member for the meeting, defining a set of subordinates 366 who are to assist with the member's defined responsibility area 362, and the like. Data base records can be updated based upon staff specific data and programmatic actions can be linked to these attributes as desired.

In another embodiment (not shown), the interface 310 can include various categories of staffs, where each category is associated with an area of responsibility. For example, staffs 332 can include coordinator staffs, resource providing staffs, topic presenters, marketing staffs, and the like. These different sub-categories can be individually selected for a set of actions, such as chatting or emailing with topic presenters only. In one embodiment, the staffs 322 can be a top level of a decomposable hierarchy, which can be selectively expanded or contracted to show/hide sub-categories of staffs 332.

In one embodiment, the behavior, display, and configuration options for the staffs 332 control can be user configured. For example, an authorized user (e.g., a meeting chairperson or an IT administrator) can define new staffs 332 sub-categories and/or staff specific attributes. Additionally, although shown from a chairperson perspective (where all staffs are visible) the interface 310 can be configured for a specific staff member. For example, an interface 310 variant for a staff member may include an additional field (not shown) showing a meeting chairperson. A staff member in charge of a staff sub-category may have a section specific to those sub-category members, over whom chairperson “level” of control is permitted. Further, all staff at a same “level” can be permitted to initiate communicates with one or more staff members on that level, using an interface 310 variant adapted specifically for a staff member.

FIGS. 4A and 4B (together considered FIG. 4) is a user interface 410 showing a calendar entry for a meeting and a set of staff-related options in accordance with an embodiment of the inventive arrangements disclosed herein. In one embodiment, the interface 410 can be an interface used in system 100 and/or method 200. Also, interface 410 can show one view of an interface that also includes a view similar to interface 310, where meeting staff members are defined along with staff specific attributes. Additionally, although interface 410 shows a calendar entry it is presented to generically represent a type of interface able to be linked to a meeting management system in which staffs are defined. Other interfaces having programmatic relationships to meetings and meeting staff are also contemplated. Such interfaces can include, for example, chat interfaces having meeting specific categories of chat participants (e.g., staffs can appear as an IM category of users), email interfaces having automatically defined staff specific distribution lists (i.e., a new distribution list for a meeting staff can be established automatically when interface 310 defines staffs for a meeting), resource reservation system interfaces (i.e., staff members assigned to a meeting can be automatically granted permission to requisition and/or reserve resources for meeting specific purposes), and the like.

Turning to specifics of interface 410, interface 410 shows a specific calendar day 412 and events scheduled for that day. The events can include a meeting 414 scheduled from 11:00 am to 5:00 pm, for example. The meeting 414 can have a meeting title 416, a meeting location 418 and a meeting chairperson 419. Various interactive options can be programmatically linked to the meeting entry, which include options specific to meeting staff members. These options can be selected or triggered in numerous ways, such as through keyboard combinations (e.g., hot key triggers), though a menu bar, through a tool bar, through a context sensitive pop-up, and the like. Context sensitive pop-up 420 can, for example, appear when the meeting entry 414 is right mouse clicked; the menu 430 can appear when an owner actions menu is selected; and, communication menu 440 can appear when a communication menu icon is selected.

The pop-up 420 can include an option showing a chairperson 422 with an expansion that when selected will show additional staff members assigned to the meeting. A send message 424 option is also included that permits a communication to be sent to all participants, all participants who have responded to a meeting invitation, all participants who have not responded to an invitation, and to events staff. Additionally, an assign to-do option (not shown) can assign a to-do object to the events staff in general or to a specific (selectable) member of the events staff.

The menu 430 can include numerous actions that an interface 410 user is permitted to perform. These actions can include, for example, an option to send a message to a meetings staffs 432 and/or to assign a to-do object to the events staffs 434. Menu 430 shows that many options available through one interface control can be redundant with options available through another control, such as pop-up 420. Further, a level of granularity of actions of a related option can vary depending upon which interface element 420, 430 is selected. For example, the options under 430 for establishing a to-do object can provide a finer grained control (not shown) compared to approximately equivalent options available through menu 420.

Communication menu 440 shows a variety of options to initiate communications with meeting participants, which includes specific communication options for staff. For example, an option to initiate a chat 442 with all staff members can be included. This option 442 can be implemented as an expandable category so that sub-categories for chatting with presenters 444, marketing staff 445, and coordination staff 446 can be included. These options 444-446 can in turn be further expandable to permit chatting with lower level categories of staff and/or with specific members of staff included under a selected sub-category 444-446. Different types of communications (not shown) are also contemplated, such as emailing, faxing, video teleconferencing, co-browsing, VOIP communicating, and the like. The presentation and composition of interface objects can be configured by a user in one contemplated embodiment, which can permit a user of interface 410 to add new customized staff specific interface options and/or to change default staff specific options.

It should be emphasized that the interfaces 310, 410 of FIGS. 3 and 4 are presented to illustrate a concept described herein. The scope of the invention is not to be construed as limited to controls, arrangements, circumstances, or other implementation choices illustrated in FIGS. 3 and 4. For example, although graphical user interfaces (GUIs) are shown in FIGS. 3 and 4, the concepts expressed therein can be adapted for a voice user interface (VUI), a multimodal interface, a text only interface, a constrained interface of a mobile computing device, and the like. Further, the text boxes, menus, toolbars, pop-ups, and the like shown can be implemented as different control types designed to perform a similar purpose as those illustrated.

The diagrams in FIGS. 1-4 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for designating staff of a meeting comprising:
identifying a staffs element of a user interface for editing or adding meeting software objects, wherein said staffs element is one of a plurality of different interface elements, wherein other ones of the interface elements accept input that define participants of a meeting who are not considered staff for that meeting;
receiving input from a user entered into the staff's element;
acquiring a user selection to save details of a currently presented meeting object;
parsing a set of at least one user considered staff from the received input entered into the staff's element;
determining a unique identifier for each staff user in the parsed set; and
storing at least one record in a meeting data store that indexes each of the determined unique identifiers against a meeting identifier such that these determined unique identifiers signify that associated users are to be considered staff for the meeting object.

2. The method of claim 1, wherein the other ones of the interface elements that accept input that define participants comprise at least one of a required participant's element, an optional participant's element, and a for-your-information participant's element.

3. The method of claim 1, further comprising:
presenting said meeting object within an interface;
receiving a user selection of the presented meeting object; and
responsive to the user selection of the presented meeting object, providing a plurality of options relating to the meeting object, wherein at least one of the plurality of options is a staffs option specific to those users previously designated as staff based upon the input entered into the staffs element.

4. The method of claim 3, further comprising:
receiving a user selection of the staffs option; and
performing at least one programmatic action responsive to receiving the user selection of the staffs option, wherein the at least one programmatic action utilizes users designated as staff for the meeting object as variable parameters, as determined by querying the meeting data store.

5. The method of claim 1, further comprising:
presenting a user selectable option related to a meeting object to communicate with meeting staff members;
detecting a selection of the user selectable option;
querying the meeting data store to determine the unique identifiers of users considered staff for the meeting corresponding to the meeting object; and
initializing a communication involving a user who selected the user selectable option and each of the users returned by querying the meeting data store.

6. The method of claim 1, further comprising:
presenting a calendar, wherein said calendar comprises said meeting object;
receiving a user selection of the meeting object; and
presenting a plurality of options for interacting with the meeting object, wherein said plurality of options comprise at least one staff option to communicate with staff associated with the meeting object, wherein when said at least one staff option is selected, said meeting data store is queried to determine which users are to be considered staff for the meeting object.

7. The method of claim 6, wherein said at least one option to communicate with staff comprises an option to perform at least one communication action from a group of actions consisting of sending an email message to each of the users designated as staff for the meeting object, establishing a voice conference with each of the users designated as staff for the meeting object, and establishing a real time communication in which text is able to be exchanged with each of the users designated as staff for the meeting object.

8. A computer program product for designating staff of a meeting, the computer program product comprising:
a computer usable medium having computer usable program code embodied therewith, the computer usable program code comprising:
computer usable program code configured to identify a staffs element of a user interface for editing or adding meeting software objects, wherein said staffs element is one of a plurality of different interface elements, wherein other ones of the interface elements accept input that define participants of a meeting who are not considered staff for that meeting;
computer usable program code configured to receive input from a user entered into the staff's element;
computer usable program code configured to acquire a user selection to save details of a currently presented meeting object;
computer usable program code configured to parse a set of at least one user considered staff from the received input entered into the staff's element;
computer usable program code configured to determine a unique identifier for each staff user in the parsed set; and
computer usable program code configured to store at least one record in a meeting data store that indexes each of the determined unique identifiers against a meeting identifier such that these determined unique identifiers signify that associated users are to be considered staff for the meeting object.

9. A system for managing meetings where staff are distinguished from other meeting participants comprising:
a meeting management software program stored in a machine usable medium configured to receive, manage, and store meeting specific information and to perform a plurality of programmatic actions related to the meeting specific information;
a meeting data store configured to store digitally encoded information comprising the meeting specific information used by the meeting management software program;
a user interface of the meeting management software program comprising a meeting establishment view, said meeting establishment view comprising a plurality of interface controls for establishing specifics for a meeting, said meeting establishment view comprising a staffs element configured to accept input defining at least one user who is to be considered a staff member for the meeting.

10. The system of claim 9, wherein said user interface further comprises:
a location section configured to establish location specifics for a meeting based on user input;
a time section configured to establish time specifics for the meeting event based upon user input; and
a participant section configured to establish at least one users who are to receive information for the meeting, said information for the meeting comprising said established location specifics and said established time specifics, wherein said participant section comprises a staff's element.

11. The system of claim 9, wherein said meeting data store is configured to store a plurality of indexed database records stored in database tables, wherein one of said database tables is a meeting table that has a primary key of a meeting identifier, wherein said meeting table has an attribute defining a staff group identifier and a chairperson identifier, wherein another of said database tables is a staff-user associative table that associates staff members of a given meeting to user identifiers, wherein said staff-user associative table has an attribute that is the staff group identifier and has an attribute for a user identifier.

12. The system of claim 9, further comprising:
calendaring software stored in a machine usable medium configured to present temporally organized meeting objects in a calendar view, wherein said calendar view comprises a user selectable option to communicate with staff members associated with a meeting of a meeting object having focus within the calendar view.

13. The system of claim 9, further comprising:
communication software stored in a machine usable medium configured to permit a user to communicate with a plurality of other users, wherein said communication software establishes a plurality of user categories, wherein one of said user categories is related to specific meetings, wherein a subcategory of said meeting category is for meeting staff, wherein membership in the meeting staff subcategory of the meeting category is defined by the set of users input into the staffs element of the user interface of the meeting management software program.

14. A user interface comprising:
a location section configured to establish location specifics for a meeting based on user input;
a time section configured to establish time specifics for the meeting event based upon user input; and
a participant section configured to establish at least one user who is to receive information for the meeting, said information for the meeting comprising said established location specifics and said established time specifics, wherein said participant section comprises a staffs element, wherein said staffs element is configured to accept input defining at least one user who is to be considered a staff member for the meeting.

15. The user interface of claim 14, wherein said interface is an interface of a meeting management software program, wherein said meeting management software program is configured to store meeting specific information entered via the location section, the time section and the participant section within a data store in a manner in which staff members defined by the staff element are indexed against the meeting in a programmatically query-able fashion.

16. The user interface of claim 14, further comprising:
a meeting notice control configured to convey a message to each of the users established by user input entered into the participant section responsive to a selection of the meeting notice control, wherein said conveyed message comprises said information for the meeting.

17. The user interface of claim 14, further comprising:
a meeting establishment view comprising said location section, said time section, and said participant section; and
a calendaring view configured to present a meeting object within a calendar object organized temporally in accordance with the time specifics of the meeting event, said calendaring view comprising at least one user selectable communication option configured to upon selection establish a communication with each user defined by the staffs element.

18. The user interface of claim 17, wherein said communication option is an option of a context-sensitive menu presented upon a user selection of the meeting object presented within the calendaring view.

19. The user interface of claim 14, wherein said user interface comprises a graphical user interface (GUI).

20. The user interface of claim 14, wherein said user interface comprises a voice user interface (GUI).
